(19) United States
(12) Patent Application Publication
(10) Pub. No.: US 2026/0121578 A1
(43) Pub. Date: Apr. 30, 2026

(54) SOLAR MODULE EDGE HAIL PROTECTION

(71) Applicant: Nextracker LLC, Fremont, CA (US)

(72) Inventors: Ning Liu, Folsom, CA (US); Madeleine Davis Kho, Oakland, CA (US); Ricardo Delgado-Nanez, San Jose, CA (US); Kent Lydell Whitfield, Mountain View, CA (US); Alexander W. AU, Oakland, CA (US)

(21) Appl. No.: 19/366,678

(22) Filed: Oct. 23, 2025

Related U.S. Application Data
(60) Provisional application No. 63/713,793, filed on Oct. 30, 2024.

(51) Int. Cl. H02S 20/32; H02S 30/10

(52) U.S. Cl. CPC H02S 20/32; H02S 30/10

(57) ABSTRACT

Described herein are systems and methods for reducing damage to solar tracker systems during severe weather, such as hailstorms. In one example, a solar module assembly, with edge protection against hail damage, includes a solar module that holds a plurality of photovoltaic cells, the solar module having a front surface and a sidewall extending from the front surface. A frame having a frame wall, which includes a first wall, is disposed about a perimeter of the solar module sidewall and supports the solar module. Further, a hail absorption wall extends along and is spaced from the first wall. The hail absorption wall is attached to the frame and resilient and deflectable towards the first wall. The hail absorption wall absorbs impact energy from hail falling in a direction towards the first wall.

### RELATED APPLICATIONS

This application claims the benefit of U.S. Provisional Patent Application No. 63/713,793, filed Oct. 30, 2024, the entire contents of which are incorporated herein by reference.

### TECHNICAL FIELD

This disclosure relates generally to solar tracker systems, and more particularly to systems and methods of providing hail protection for solar modules within solar tracker systems.

### BACKGROUND

Solar cells and solar panels are most efficient in sunny conditions when oriented towards the sun at a certain angle. Many solar panel systems are designed in combination with solar trackers, which follow the sun's trajectory across the sky from east to west to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds of individual solar modules that are mechanically coupled to support structures.

Adjusting massive solar trackers requires power to drive the solar array as it follows the sun. As will be appreciated, the greater the load, the greater the amount of power necessary to drive the solar tracker. An additional design constraint of such systems is the rigidity required to accommodate the weight of the solar arrays and at times significant wind loading.

Further, many solar trackers use solar modules comprising glass, which is susceptible to damage from severe weather. For example, hail may cause damage to a solar module thereby greatly diminishing the solar module's ability to generate power, or at times, render the solar module completely inoperable. The present disclosure seeks to address the shortcomings of prior tracker systems.

### SUMMARY

In general, the present disclosure relates generally to solar tracker systems, and more particularly to systems and methods of providing hail protection for solar modules within solar tracker systems. In one example, a solar tracking system may include a plurality of solar tracker rows arranged in parallel in a north-south direction, wherein each solar tracker row may include a plurality of support piers, a torque tube extending along the row and rotatably supported on the plurality of support piers, and a plurality of solar module assemblies with edge protection against hail damage coupled to the torque tube. Each solar module assembly may include a first side and a second side, opposite the first side, and a solar module that holds a plurality of photovoltaic cells. The solar module may include a front surface configured to face the sun and a sidewall extending away from the front surface. A frame having a frame wall disposed about a perimeter of the solar module sidewall and supporting the solar module may include a first wall on the first side, and a hail absorption wall extending along and spaced from the first wall. The hail absorption wall may be attached to the frame and may shield a portion of the first side of each one of the solar module assemblies from hail falling in a direction towards the first wall.

Additionally or alternatively, the hail absorption wall may be resilient and deflectable towards the first wall, the hail absorption wall absorbing impact energy from hail falling in a direction towards the first wall.

Additionally or alternatively, the hail absorption wall may form a convex surface extending away from the first wall.

Additionally or alternatively, the convex surface forms one or more sharp edges, whereby hail falling on the sharp edges may be broken into fragments.

Additionally or alternatively, the sidewall may extend in a direction perpendicular to the front surface and defining a depth direction, the sidewall may extend forward in the depth direction to a sidewall front edge and rearward in the depth direction to a sidewall rear edge.

Additionally or alternatively, the first wall may extend forward in the depth direction to a first wall front edge and rearward in the depth direction to a first wall rear edge, the first wall front edge may extend further forward in the depth direction than the sidewall front edge, the first wall rear edge may extend further rearward in the depth direction than the sidewall rear edge.

Additionally or alternatively, the hail absorption wall may extend forward in the depth direction past the first wall front edge.

Additionally or alternatively, the hail absorption wall may extend rearward in the depth direction past the sidewall rear edge.

Additionally or alternatively, the space between the hail absorption wall and the first wall may contain foam, the foam absorbing impact energy from the hail absorption wall deflecting towards the first wall in response to hail striking the hail absorption wall.

Additionally or alternatively, the hail absorption wall may be formed as a part of the first wall.

Additionally or alternatively, the hail absorption wall may be formed as a component that is separate from the first wall.

Additionally or alternatively, the hail absorption wall may be coupled to the first wall via friction fit, snap fit, or via connectors.

In another example, a solar module assembly with edge protection against hail damage may include a first sun-facing side and a second opposing side, and a solar module having a sidewall extending from the front surface. A frame may include a frame wall disposed about a perimeter of the solar module sidewall and supporting the solar module, the frame wall having a first wall on the first side, and a hail absorption wall may extend along and spaced from the first wall. The hail absorption wall may be attached to the frame and shielding a portion of the first sun-facing side from hail falling in a direction towards the first wall.

Additionally or alternatively, the solar module may hold a plurality of photovoltaic cells. The solar module may include a front surface and configured such that the plurality of photovoltaic cells generates a voltage when solar radiation passes through the front surface, the solar module.

Additionally or alternatively, the sidewall may extend in a direction perpendicular to the front surface defining a depth direction, the sidewall may extend forward in the depth direction to a sidewall front edge and rearward in the depth direction to a sidewall rear edge.

Additionally or alternatively, the first wall may extend forward in the depth direction to a first wall front edge and rearward in the depth direction to a first wall rear edge, the first wall front edge extending further forward in the depth direction than the sidewall front edge, the first wall rear edge extending further rearward in the depth direction than the sidewall rear edge.

Additionally or alternatively, the hail absorption wall may extend forward in the depth direction past the first wall front edge.

Additionally or alternatively, the hail absorption wall may extend rearward in the depth direction past the sidewall rear edge.

Additionally or alternatively, the hail absorption wall may be formed as a part of the first wall.

Additionally or alternatively, the hail absorption wall may be formed as a component that is separate from the first wall.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker;

FIG. 2 is a schematic, top view of a solar tracking system;

FIG. 3A is a schematic, perspective view of a solar module assembly in an example hail stow position;

FIG. 3B is a schematic, side view of the solar module assembly of FIG. 3A in the example hail stow position;

FIG. 4A is an enlarged view of a portion of the solar module assembly of FIG. 3B, shown in Circle 4;

FIG. 4B is a cross-sectional view of the portion of the solar module assembly, as in FIG. 4A;

FIG. 5A is an enlarged view of a portion of the solar module assembly of FIG. 3B, shown in Circle 4, including an example hail absorption wall in accordance with the disclosure;

FIG. 5B is a cross-sectional view of the portion of the solar module assembly, as in FIG. 5A, including the example hail absorption wall;

FIG. 5C is an enlarged view of a portion of the solar module assembly of FIG. 3B, shown in Circle 4, including the example hail absorption wall, illustrating a protection zone;

FIG. 6A is an enlarged view of a portion of the solar module assembly of FIG. 3B, shown in Circle 4, including an example hail absorption wall in accordance with the disclosure;

FIG. 6B is a cross-sectional view of the portion of the solar module assembly, as in FIG. 6A, including the example hail absorption wall;

FIG. 7A is an example hail absorption wall in accordance with the disclosure;

FIG. 7B is an enlarged view of a portion of the solar module assembly of FIG. 3B, shown in Circle 4, including the example hail absorption wall of FIG. 7A;

FIG. 7C is a cross-sectional view of the portion of the solar module assembly, as in FIG. 7B, including the example hail absorption wall of FIG. 7A;

FIG. 8A is an example hail absorption wall in accordance with the disclosure;

FIG. 8B is an enlarged view of a portion of the solar module assembly of FIG. 3B, shown in Circle 4, including the example hail absorption wall of FIG. 8A;

FIG. 8C is a cross-sectional view of the portion of the solar module assembly, as in FIG. 8B, including the example hail absorption wall of FIG. 8A;

FIG. 9A is an example hail absorption wall in accordance with the disclosure;

FIG. 9B is an enlarged view of a portion of the solar module assembly of FIG. 3B, shown in Circle 4, including the example hail absorption wall of FIG. 9A;

FIG. 9C is a cross-sectional view of the portion of the solar module assembly, as in FIG. 9B, including the example hail absorption wall of FIG. 9A;

FIG. 10A is an example hail absorption wall in accordance with the disclosure;

FIG. 10B is an enlarged view of a portion of the solar module assembly of FIG. 3B, shown in Circle 4, including the example hail absorption wall of FIG. 10A;

FIG. 10C is a cross-sectional view of the portion of the solar module assembly, as in FIG. 10B, including the example hail absorption wall of FIG. 10A;

FIG. 10D is a bottom perspective view of the portion of the solar module assembly of FIG. 10B, including the example hail absorption wall of FIG. 10A;

FIG. 10E is a cross-sectional view of the portion of the solar module assembly, as in FIG. 10D, including the example hail absorption wall of FIG. 10A;

FIG. 11A is an example hail absorption wall in accordance with the disclosure;

FIG. 11B is an enlarged view of a portion of the solar module assembly of FIG. 3B, shown in Circle 4, including the example hail absorption wall of FIG. 11A; and

FIG. 11C is a cross-sectional, bottom perspective view of the portion of the solar module assembly, as in FIG. 11B, including the example hail absorption wall of FIG. 11A.

### DETAILED DESCRIPTION

The present disclosure is directed to distributed damping systems and methods for preventing damage to solar tracker systems due to hail. Photovoltaic (PV) power systems are used to generate electrical power from solar energy and may include tracking systems to increase the amount of electrical power generated. PV systems that include tracking systems may be referred to as “solar trackers.” The tracking systems may enable solar modules to be rotated to track the sun as the sun moves across the sky. Many solar trackers use solar modules comprising glass which is susceptible to damage from severe weather. For example, hail may cause damage to a solar module and render it inoperable or greatly diminish the solar module's ability to generate electrical power. Some trackers have a hail stow mode of operation where the solar modules are rotated to a non-horizontal angle to reduce the impact of the hail on the face of the solar modules. However, the stow angle alone may not reduce the impact of the hail on all surfaces of the solar modules. stability of solar tracker systems can be affected by several variables. The present disclosure describes design strategies that can be adopted to minimize damage to the solar modules that may be caused by hail.

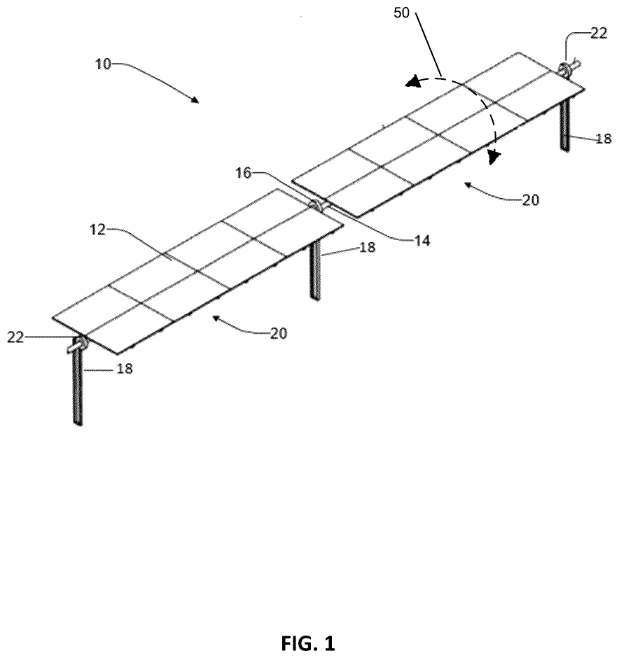

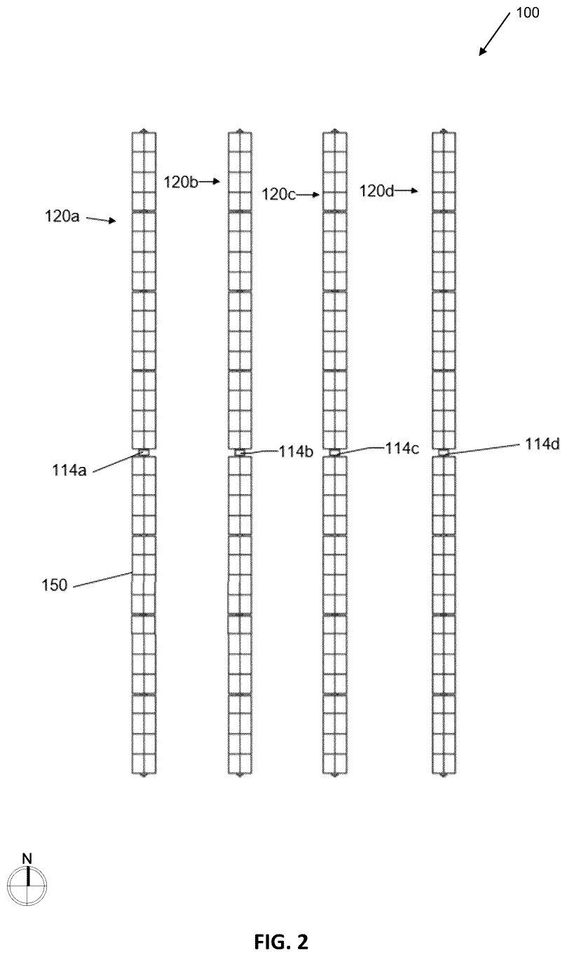

Referring now to the drawings, FIG. 1 illustrates a perspective view of a common arrangement of a solar tracker 10 provided in accordance with the present disclosure. The solar tracker 10 has bays 20 defined by the distance between ground piers 18 (generally referenced herein as piers 18). The solar tracker 10 may be a part of a larger solar tracker system that may include a plurality of solar trackers 10 arranged in rows, an example of which is shown in FIG. 2, where each row of solar trackers 10 may be referred to as a solar tracker row. FIG. 1 illustrates two bays 20 of the solar tracker 10. However, it will be appreciated that the solar tracker 10 may include four bays, six bays, ten bays, twenty bays, or any other suitable number of bays as desired. At each pier 18 is either a bearing 22 or, as shown in FIG. 1, a drive mechanism 16 shown, for example, near the center of the solar tracker 10. Each of the bearings 22 and the drive mechanism 16 are supported by one of the piers 18. Activation of the drive mechanism 16 rotates a torque tube 14 about an axis of rotation and thus rotates one or more solar modules 12 mounted to the torque tube 14 such that the solar modules 12 can be oriented to a desired position. That desired position may be a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

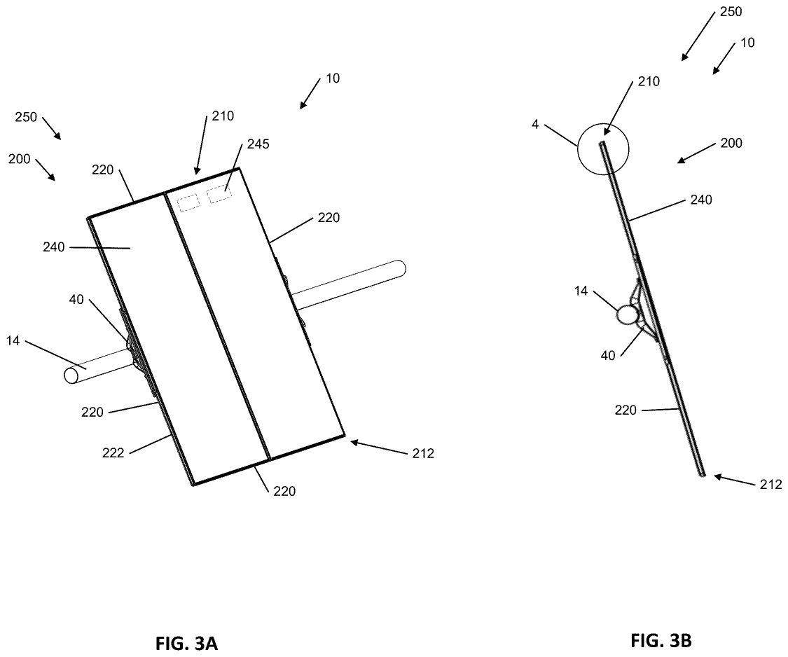

The torque tube 14 is sized (e.g., diameter, wall thickness, material) such that sag between the piers 18 is reduced or substantially eliminated and to absorb torsional loads applied to the torque tube 14 by wind loading. In addition, since there may be just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing, as indicated by arrow 50, and as further described in reference to FIGS. 3A and 3B.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. The solar module assemblies 150 may each include edge protection against hail damage, as described further herein. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

FIG. 3A is a perspective view of the solar tracker 10, as in FIG. 1 including a solar module assembly 200 in an example hail stow position 250. FIG. 3B is a side view of the solar tracker 10, illustrating the solar module assembly 200 in the hail stow position 250. Moving the solar module assembly 200 to the hail stow position 250 may reduce the amount of impact energy of hail on the solar module assembly 200. For example, the hail would strike the solar module assembly 200 at an angle rather than directly, which may provide a lower amount of impact energy. The hail stow position 250 may also be referred to as stowing. Stowing can be defined as causing a solar tracker (e.g., solar tracker 10), or plurality of solar trackers (e.g., a solar array), to rotate to a desired angle, thereby causing the top of the solar modules 200 to face the desired angle. In some examples, the desired angle can be referred to a as a stow angle. The stow angle can depend on various factors, however, in some examples, the stow angle is between −90 degrees and +90 degrees relative to horizontal. In some examples, the stow angle is approximately-75 degrees or approximately +75 degrees relative to horizontal. In some examples, the stow angle is approximately-60 degrees or approximately +60 degrees relative to horizontal. In some examples, the stow angle is approximately-50 degrees or approximately +50 degrees relative to horizontal. In some examples, the stow angle is between approximately-75 degrees and approximately-50 degrees relative to horizontal. Similarly, in some examples, the stow angle is between approximately +75 degrees and approximately +50 degrees relative to horizontal. In some examples where hail is not a concern, the stow angle is 0 degrees (e.g., parallel) to the horizontal.

In some examples, the hail stow position 250 may be a position in which the solar tracker is at a max-tilt. In some cases, stowing nearest the max-tilt is based on the current angle of the solar module. For example, if the solar modules of the solar array are already rotated at an angle of +30 degrees relative to horizontal, stowing nearest the max-tilt would include rotating the faces of the solar modules to the maximum positive angle (e.g., +75 degrees relative to horizontal). Similarly, if the solar modules of the solar array are already rotated at an angle of −25 degrees relative to horizontal, stowing nearing the max-tilt would include rotating the faces of the solar modules to the maximum negative angle (e.g., −75 degrees relative to horizontal). Rotating the faces of the solar modules to the maximum positive angle or the maximum negative angle may function to provide a 75° protection angle strategy. For example, by rotating the faces of the solar modules to the maximum positive angle or the maximum negative angle may reduce the amount of impact energy of hail on the solar module assembly 200. These are just examples.

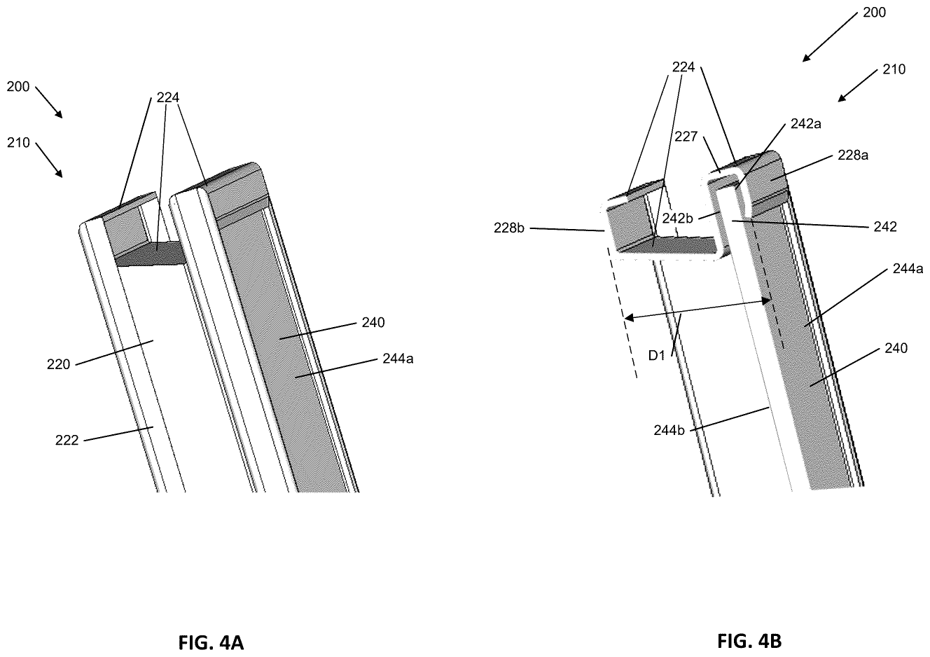

As shown in FIGS. 3A and 3B, the solar module assembly 200 may be coupled to the torque tube 14 via a bracket system 40. The solar module assembly 200 may include edge protection against hail damage, as discussed further with reference to FIGS. 4A to 11C. The solar module assembly 200 may include a solar module 240. The solar module 240 may be an example of the solar module 12, as in FIG. 1 and/or the solar module 150, as in FIG. 2. The solar module 240 may include a front surface configured to face the sun and may include a sidewall extending away from the front surface, as shown in FIG. 4B. The solar module 240 may hold a plurality of photovoltaic cells 245 which are configured to receive the light from the sun and generate a voltage when solar radiation is passed through the front surface (e.g., front surface 244a described herein).

The solar module assembly 200 may include a first side 210 and a second side 212. In some examples, the first side 210 may be considered a first, sun-facing side 210, and the second side 212 may be a second, opposing side 212. The edge protection against hail (e.g., hail absorption walls) described herein with reference to FIGS. 4A to 11C, may function to protect the first side 210 and the second side 212 of the solar module assembly 200. As illustrated in FIGS. 3A and 3B, while the solar module assembly 200 is in the hail stow position 250, the first side 210 is tilted toward an upward position, relative to the torque tube 14 and the second side 212 is tilted toward a downward position relative to the torque tube 14. However, it may be contemplated that, in the hail stow position 250, the second side 212 may be tilted toward an upward position, relative to the torque tube 14 and the first side 210 may be tilted toward a downward position relative to the torque tube 14. While the first side 210 will be referenced herein, it will be appreciated that the second side 212 of the solar module assembly 200 is a mirror image of the first side 210. Therefore, it will be appreciated that the description of the first side 210 of the solar module assembly 200 throughout further applies to the second side 212 of the solar module assembly 200.

FIG. 4A is an enlarged view of the first side 210 of the solar module assembly 200 of FIG. 3B, shown in Circle 4, and FIG. 4B is a cross-sectional view of the first side 210 of the solar module assembly 200, as in FIG. 4A. The solar module assembly 200 may include the solar module 240. The solar module 240 may include a solar module sidewall 242. The solar module sidewall 242 may extend in a direction perpendicular to a front surface 244a of the solar module 240 thereby defining a depth direction D₁. Further, the solar module sidewall 242 may extend in the depth direction D₁ forward to a sidewall front edge 242a and rearward to a sidewall rear edge 242b. The solar module assembly 200 may include a frame 220 having a frame wall 222 disposed about a perimeter of a solar module sidewall 242. The frame wall 222 may include the first wall 224 on the first side 210 of the solar module assembly 200. The first wall 224 may extend forward in the depth direction D₁ to a first wall front edge 228a and rearward in the depth direction D₁ to a first wall rear edge 228b. The first wall front edge 228a may extend forward in the depth direction D₁ beyond the sidewall front edge 242a. The first wall 224 of the frame 220 may contain a U-shaped bracket 227 that may also form part of the first wall 224 that surrounds the sidewall 242, including its front edge 242a and its rear edge 242b, thereby holding it securely in the solar module assembly 200.

When the solar module assembly 200 is in the max-tilt and/or the hail stow position 250, the sidewall 242 of the solar module 240 may be exposed and vulnerable during severe weather, such as a hailstorm. The sidewall 242 may be protected by the frame 220 of the solar module assembly 200. The frame 220 may be desirable to reduce breakage of the solar module 240 and enable a more durable long-term solar module 240 life, which may further reduce mounting system costs. The frame 220 may further provide a solid structure to aid in mounting the solar module 240 and help the solar module 240 maintain its shape and position within the solar tracker system 100. During severe weather, the frame 220 alone may not adequately protect the solar module 240. For example, the connection between the frame 220 and the solar module 240 may not be resilient enough to protect the sidewall 242 of the solar module 240. Rather, the frame 220 may simply transfer the impact energy directly to the sidewall 242 of the solar module 240, which may cause breakage, bending, or the like, of the solar module 240. Providing a hail absorption wall, as described further herein, may serve to provide resiliency to the solar module assembly 200 and absorb impact energy, thereby reducing or eliminating the amount of impact energy transferred to the sidewall 242 and/or the front surface 244a of the solar module 240.

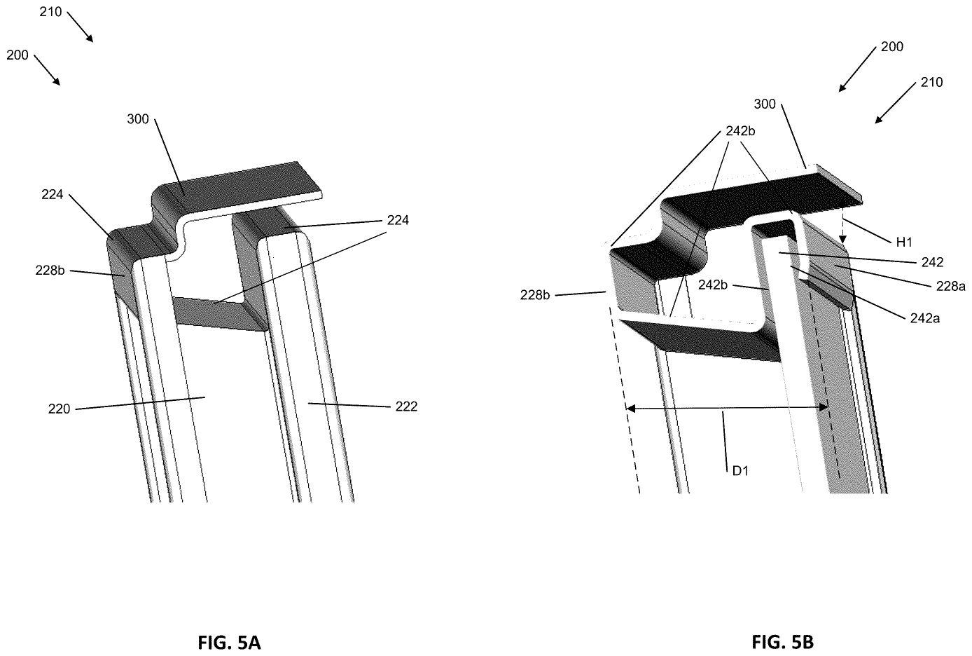

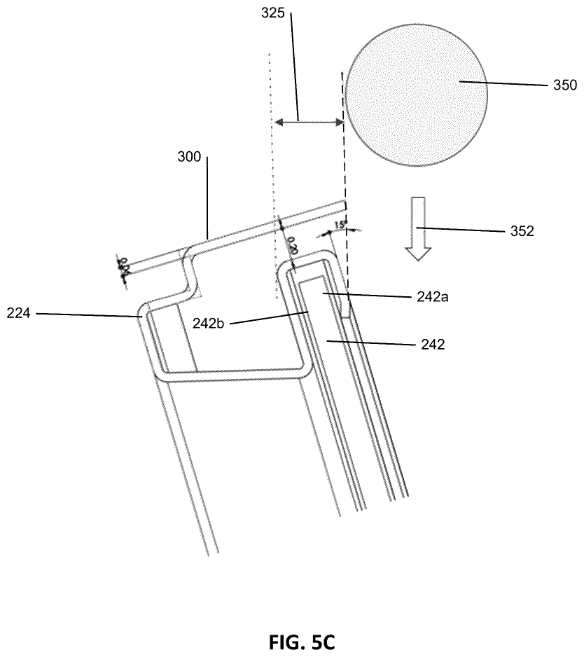

FIG. 5A is an enlarged view of the first side 210 of the solar module assembly 200 of FIG. 3B, shown in Circle 4, including an example hail absorption wall 300, and FIG. 5B is a cross-sectional view of the first side 210 of the solar module assembly, as in FIG. 5A, including the example hail absorption wall 300, and FIG. 5C is an enlarged view of the first side 210 of the solar module assembly 200 of FIG. 3B, shown in Circle 4, including the example hail absorption wall 300, illustrating a protection zone 325. As shown in FIGS. 5A to 5C, the hail absorption wall 300 may be attached to the frame 220 and may extend along the first wall 224 of the frame 220. In some examples, as shown in FIGS. 5A to 5C, the hail absorption wall 300 may be extend in a forward direction beyond the sidewall front edge 242a and further beyond the first wall front edge 228a. In some examples, the hail absorption wall 300 may be a separate piece that is adhered to the first wall 224 via connectors, friction fit, or snap-fit.

The hail absorption wall 300 may further be spaced away, as indicated by arrow H₁, from the first wall 224. In some examples, the space between the hail absorption wall 300 and the first wall 224 may contain foam. The foam may be configured to absorb impact energy from the hail absorption wall 300 deflecting towards the first wall 224 in response to hail striking the hail absorption wall 300. The hail absorption wall 300 may be configured to provide protection to the protection zone 325 of the frame 220 by shielding a portion of the first side 210 of each of the plurality of solar module assemblies 150 (e.g., solar module assembly 200) from hail falling in a direction towards the first wall 224. In some cases, the hail absorption wall 300 may be configured to shield the portion of the first side 210 of the solar module assembly 200 by providing resiliency and by being deflectable towards the first wall 224 and/or by breaking up hail into fragments. As such, the hail absorption wall 300 may be configured to absorb impact energy from hail 350 falling in a direction towards the first wall 224, as indicated by arrow 352.

As shown in FIGS. 5A to 5C, the hail absorption wall 300 may extend forward in the depth direction D₁ past the sidewall front edge 242a. The extension forward, beyond the sidewall front edge 242a may provide protection to the protection zone 325 of the sidewall 242 of the solar module 240. While the protection zone 325 is being shown in reference to the hail absorption wall 300, it may be contemplated that further hail absorption walls described herein may also provide protection to the protection zone 325. The hail absorption wall 300 is simply used for illustrative purposes in FIG. 5C.

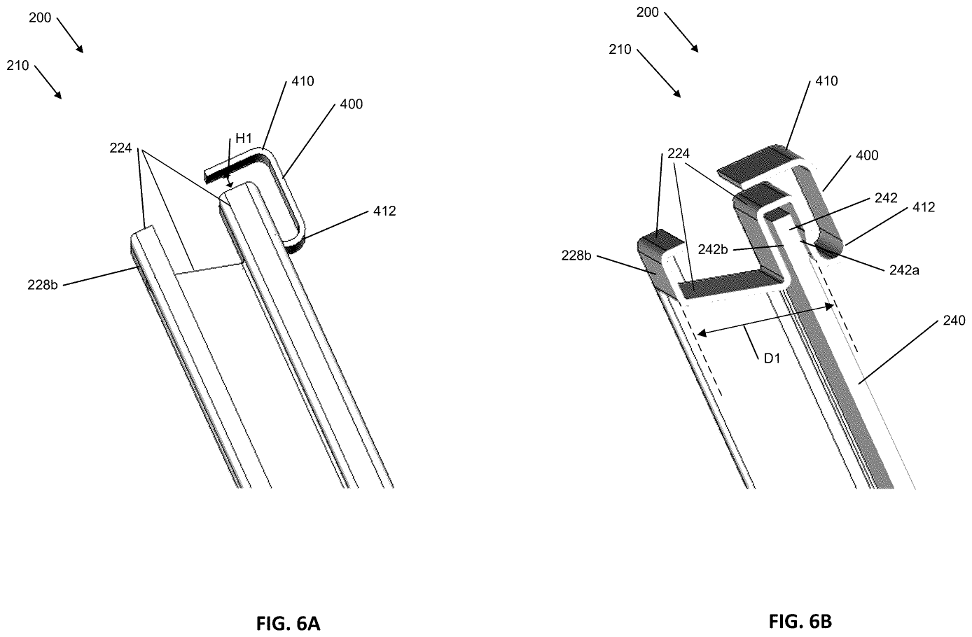

FIG. 6A is an enlarged view of the first side 210 of the solar module assembly 200 of FIG. 3B, shown in Circle 4, including an example hail absorption wall 400, and FIG. 6B is a cross-sectional view of the first side 210 of the solar module assembly 200, as in FIG. 6A, including the example hail absorption wall 400. As shown in FIGS. 6A to 6B, the hail absorption wall 400 may be attached to the frame 220 and may extend along the first wall 224 of the frame 220. In some examples, as shown in FIGS. 6A to 6B, the hail absorption wall 400 may be formed as part of the first wall 224 and extend in forward direction, beyond the sidewall front edge 242a. The hail absorption wall 400 may further include a first bend 412 and a second bend 410 thereby forming a U-shape and may extend in a rearward direction from the first wall 224 beyond the sidewall rear edge 242b. In some examples, the hail absorption wall 400 may be a separate piece that is adhered to the first wall 224 via welding, adhesives, or the like.

The hail absorption wall 400 may further be spaced away, as indicated by arrow H₁, from the first wall 224. In some examples, the space between the hail absorption wall 400 and the first wall 224 may contain foam. The foam may be configured to absorb impact energy from the hail absorption wall 400 deflecting towards the first wall 224 in response to hail striking the hail absorption wall 400. The hail absorption wall 400 may be configured to provide protection to the protection zone 325 of the sidewall 242 of the solar module 240 by shielding a portion of the first side 210 of each of the plurality of solar module assemblies 150 (e.g., solar module assembly 200) from hail falling in a direction towards the first wall 224. In some cases, the hail absorption wall 400 may be configured to shield the portion of the first side 210 of the solar module assembly 200 by providing resiliency and by being deflectable towards the first wall 224 and/or by breaking up hail into fragments. As such, the hail absorption wall 400 may be configured to absorb impact energy from hail 350 falling in a direction towards the first wall 224, as indicated by arrow 352 in FIG. 5C.

As shown in FIGS. 6A to 6B, the hail absorption wall 400 may extend forward in the depth direction D₁ past the sidewall front edge 242a. The extension forward, beyond the sidewall front edge 242a may provide protection to the protection zone 325 of the sidewall 242.

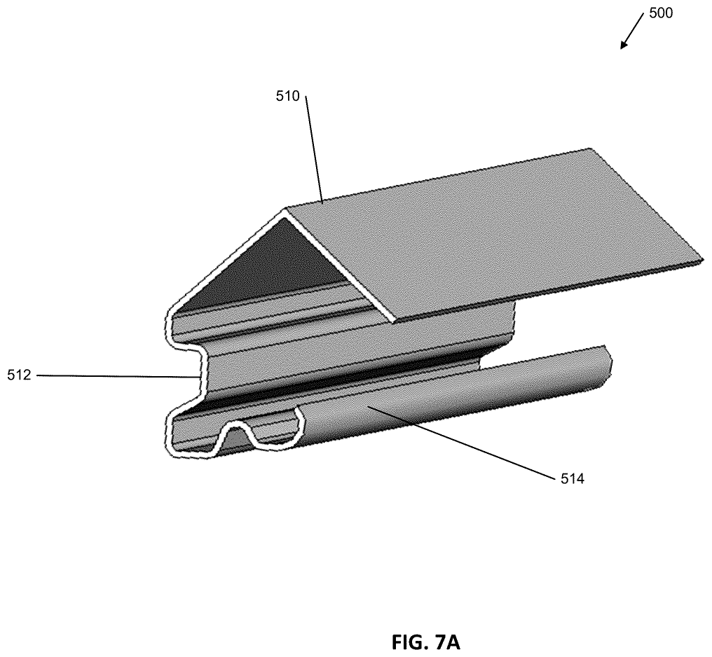

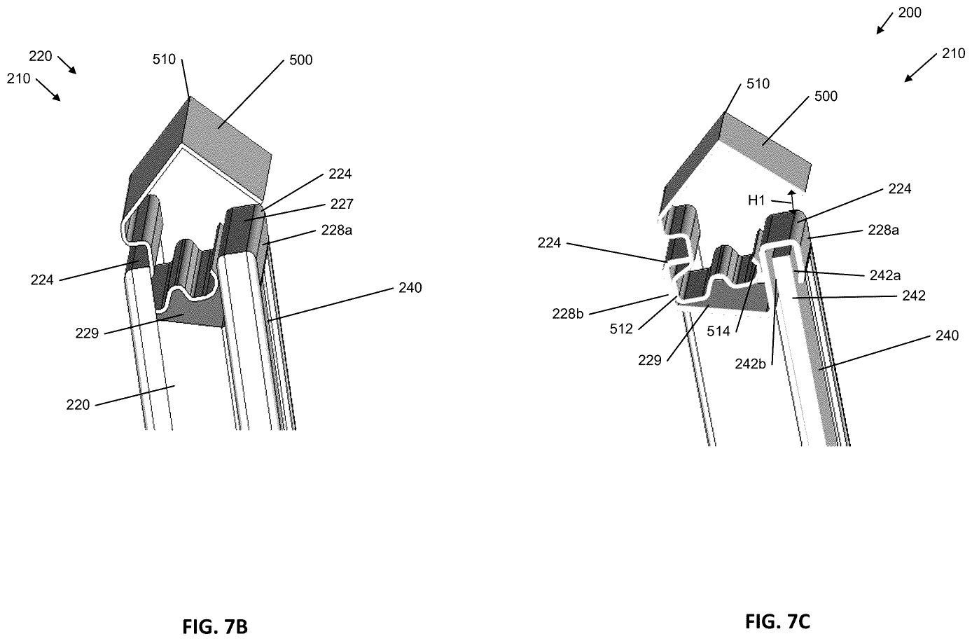

FIG. 7A is an example hail absorption wall 500, FIG. 7B is an enlarged view of the first side 210 of the solar module assembly 200 of FIG. 3B, shown in Circle 4, including the hail absorption wall 500, and FIG. 7C is a cross-sectional view of the first side 210 of the solar module assembly 200, as in FIG. 7B, including the example hail absorption wall 500. As shown in FIGS. 7A to 7C, the hail absorption wall 500 may be attached to the frame 220 and may extend along the first wall 224 of the frame 220. In some examples, as shown in FIGS. 7A to 7C, the hail absorption wall 500 may be formed as a separate component and may be inserted within a channel 229 of the first wall 224 of the frame 220. The hail absorption wall 500 may be held within the channel 229 via friction fit, snap fit, and/or may be adhered in place via an adhesive, welding, or the like. The hail absorption wall 500 may extend in forward direction, beyond the sidewall front edge 242a, and the hail absorption wall 500 may further extend in a rearward direction beyond the sidewall rear edge 242b.

The hail absorption wall 500 may further be spaced away, as indicated by arrow H₁, from the first wall 224. In some examples, the space between the hail absorption wall 500 and the first wall 224 may contain foam. The foam may be configured to absorb impact energy from the hail absorption wall 500 deflecting towards the first wall 224 in response to hail striking the hail absorption wall 500. The hail absorption wall 500 may be configured to provide protection to the protection zone 325 of the sidewall 242 by shielding a portion of the first side 210 of each of the plurality of solar module assemblies 150 (e.g., solar module assembly 200) from hail falling in a direction towards the first wall 224. In some cases, the hail absorption wall 500 may be configured to shield the portion of the first side 210 of the solar module assembly 200 by providing resiliency and by being deflectable towards the first wall 224 and/or by breaking up hail into fragments. As such, the hail absorption wall 500 may be configured to absorb impact energy from hail 350 falling in a direction towards the first wall 224, as indicated by arrow 352 in FIG. 5C.

As shown in FIGS. 7A to 7C, the hail absorption wall 500 may form a convex surface 510 extending away from the first wall 224. In some examples, the convex surface 510 may form one or more sharp edges. The sharp edges may function to break up or shatter hail, resulting in smaller and lighter hail fragments that may fall from the hail absorption wall 500 onto other surfaces (e.g., the sidewall 242, the solar module 240, etc.). Further, the hail absorption wall 500 may form a U-shaped bend 512 configured to be positioned around the first wall rear edge 228b and further extend along the channel 229 of the frame 220 and then forming a bend 514 that engages with the first wall front edge 228a. The contact between the U-shaped bend 512 and the bend 514 with the first wall rear edge 228b and the first wall front edge 228a secures the hail absorption wall 500 in position within the solar module assembly 200.

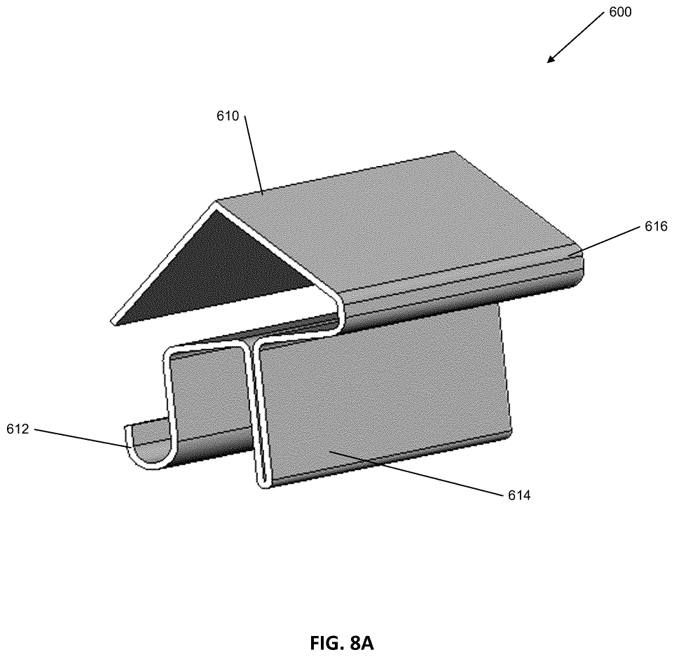

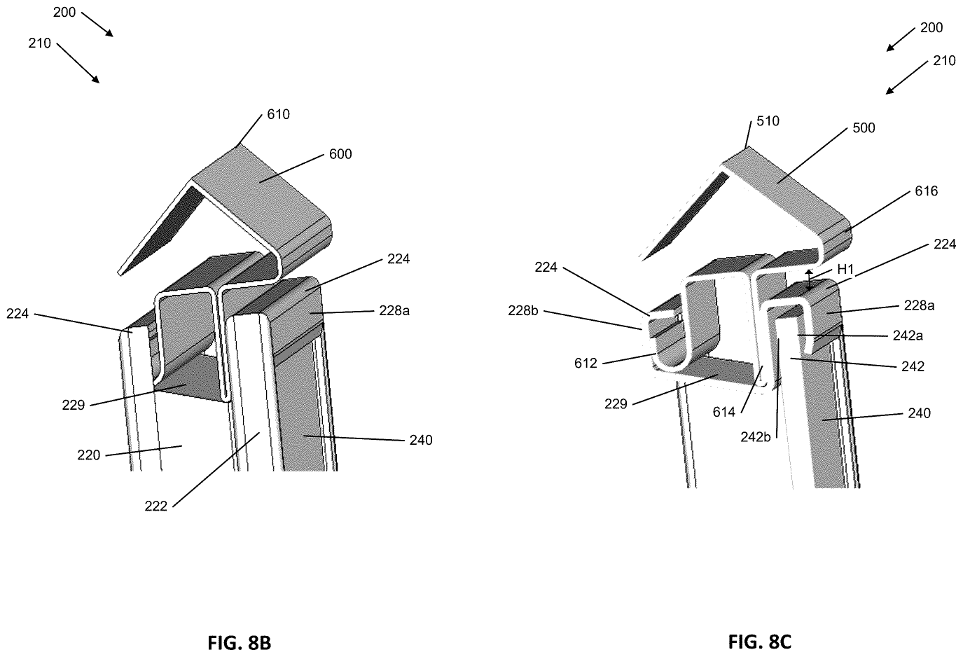

FIG. 8A is an example hail absorption wall 600, FIG. 8B is an enlarged view of the first side 210 of the solar module assembly 200 of FIG. 3B, shown in Circle 4, including the hail absorption wall 600, and FIG. 8C is a cross-sectional view of the first side 210 of the solar module assembly 200, as in FIG. 8B, including the example hail absorption wall 600. As shown in FIGS. 8A to 8C, the hail absorption wall 600 may be attached to the frame 220 and may extend along the first wall 224 of the frame 220. In some examples, as shown in FIGS. 8A to 8C, the hail absorption wall 600 may be formed as a separate component and may be inserted within the channel 229 of the frame 220 between the first wall rear edge 228b and the first wall front edge 228a. The hail absorption wall 600 may be held between the first wall rear edge 228b and the first wall front edge 228a via friction fit, snap fit, and/or may be adhered in place via an adhesive, welding, or the like. The hail absorption wall 600 may extend in forward direction, beyond the sidewall front edge 242a. The hail absorption wall 600 may further form a U-shape 616 and may extend in a rearward direction from the first wall 224 beyond the sidewall rear edge 242b, and the hail absorption wall 600 may further extend in a rearward direction beyond the first wall rear edge 228b.

The hail absorption wall 600 may further be spaced away, as indicated by arrow H₁, from the first wall 224. In some examples, the space between the hail absorption wall 600 and the first wall 224 may contain foam. The foam may be configured to absorb impact energy from the hail absorption wall 600 deflecting towards the first wall 224 in response to hail striking the hail absorption wall 600. The hail absorption wall 600 may be configured to provide protection to the protection zone 325 of the sidewall 242 by shielding a portion of the first side 210 of each of the plurality of solar module assemblies 150 (e.g., solar module assembly 200) from hail falling in a direction towards the first wall 224. In some cases, the hail absorption wall 600 may be configured to shield the portion of the first side 210 of the solar module assembly 200 by providing resiliency and by being deflectable towards the first wall 224 and/or by breaking up hail into fragments. As such, the hail absorption wall 600 may be configured to absorb impact energy from hail 350 falling in a direction towards the first wall 224, as indicated by arrow 352 in FIG. 5C.

As shown in FIGS. 8A to 8C, the hail absorption wall 600 may form a convex surface 610 extending away from the first wall 224. In some examples, the convex surface 610 may form one or more sharp edges. The sharp edges may function to break up or shatter hail, resulting in smaller and lighter hail fragments that may fall from the hail absorption wall 500 onto other surfaces (e.g., the sidewall 242, the solar module 240, etc.). Further, the hail absorption wall 600 may form a U-shaped bend 612 configured to be positioned against an inner side of the first wall rear edge 228b and further extend within the channel 229 of the frame 220, then forming a bend 614 that engages with the first wall front edge 228a. The contact between the U-shaped bend 612 and the bend 614 with the first wall front edge 228a and the first wall rear edge 228b secures the hail absorption wall 600 in position within the solar module assembly 200.

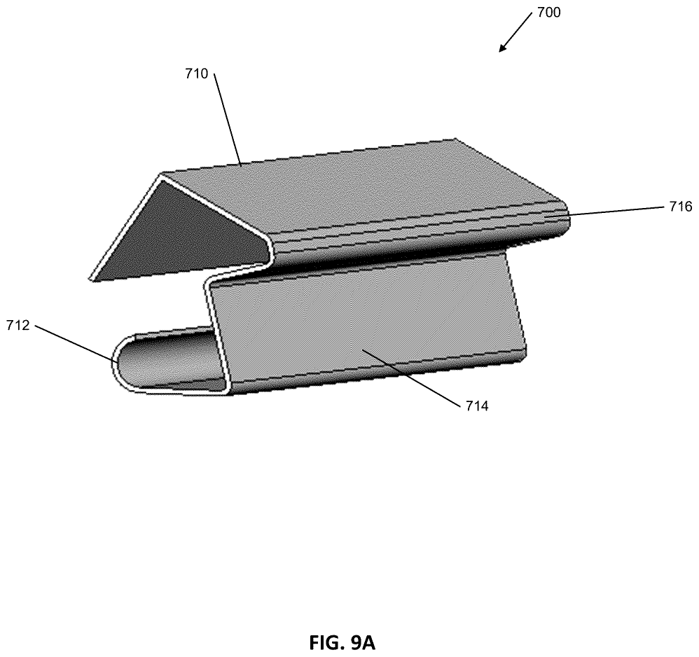

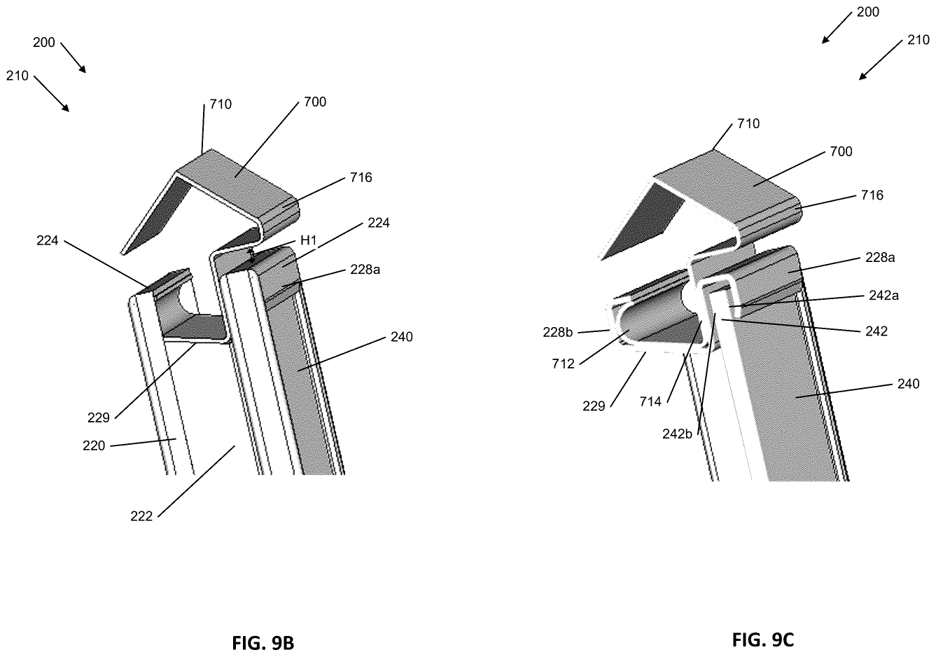

FIG. 9A is an example hail absorption wall 700, FIG. 9B is an enlarged view of the first side 210 of the solar module assembly 200 of FIG. 3B, shown in Circle 4, including the hail absorption wall 700, and FIG. 9C is a cross-sectional view of the first side 210 of the solar module assembly 200, as in FIG. 9B, including the hail absorption wall 700. As shown in FIGS. 9A to 9C, the hail absorption wall 700 may be attached to the frame 220 and may extend along the first wall 224 of the frame 220. In some examples, as shown in FIGS. 9A to 9C, the hail absorption wall 700 may be formed as a separate component and may be inserted between the first wall rear edge 228b and the first wall front edge 228a. The hail absorption wall 700 may be held between the first wall rear edge 228b and the first wall front edge 228a via friction fit, snap fit, and/or may be adhered in place via an adhesive, welding, or the like. The hail absorption wall 700 may extend in forward direction, beyond the sidewall front edge 242a. The hail absorption wall 700 may further form a U-shape 716 and may extend in a rearward direction from the first wall 224 beyond the sidewall rear edge 242b, and the hail absorption wall 700 may further extend in a rearward direction beyond the first wall rear edge 228b.

The hail absorption wall 700 may further be spaced away, as indicated by arrow H₁, from the first wall 224. In some examples, the space between the hail absorption wall 700 and the first wall 224 may contain foam. The foam may be configured to absorb impact energy from the hail absorption wall 700 deflecting towards the first wall 224 in response to hail striking the hail absorption wall 700. The hail absorption wall 700 may be configured to provide protection to the protection zone 325 of the sidewall 242 by shielding a portion of the first side 210 of each of the plurality of solar module assemblies 150 (e.g., solar module assembly 200) from hail falling in a direction towards the first wall 224. In some cases, the hail absorption wall 700 may be configured to shield the portion of the first side 210 of the solar module assembly 200 by providing resiliency and by being deflectable towards the first wall 224 and/or by breaking up hail into fragments. As such, the hail absorption wall 700 may be configured to absorb impact energy from hail 350 falling in a direction towards the first wall 224, as indicated by arrow 352 in FIG. 5C.

As shown in FIGS. 9A to 9C, the hail absorption wall 700 may form a convex surface 710 extending away from the first wall 224. In some examples, the convex surface 710 may form one or more sharp edges. The sharp edges may function to break up or shatter hail, resulting in smaller and lighter hail fragments that may fall from the hail absorption wall 500 onto other surfaces (e.g., the sidewall 242, the solar module 240, etc.). Further, the hail absorption wall 700 may form a U-shaped bend 712 configured to be positioned against an inner side of the first wall rear edge 228b and further extend within the channel 229 of the frame 220, then forming a bend 714 that engages with the first wall front edge 228a. The contact between the U-shaped bend 712 and the bend 714 with the first wall rear edge 228b and the first wall front edge 228a secures the hail absorption wall 600 in position within the solar module assembly 200.

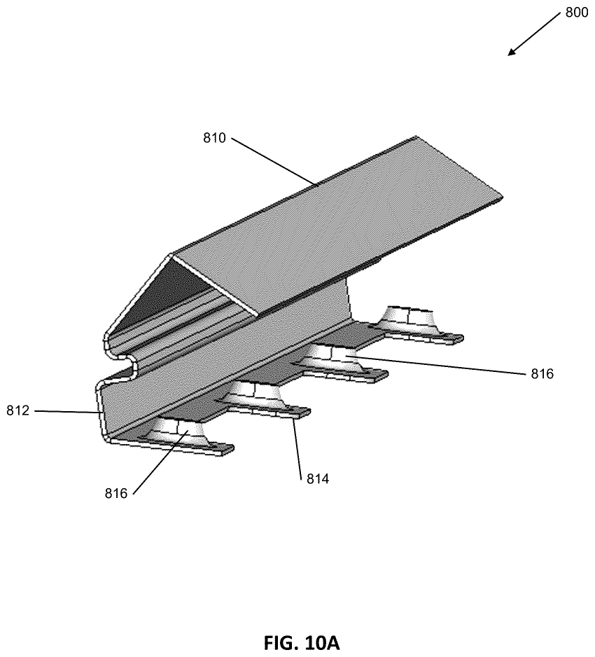

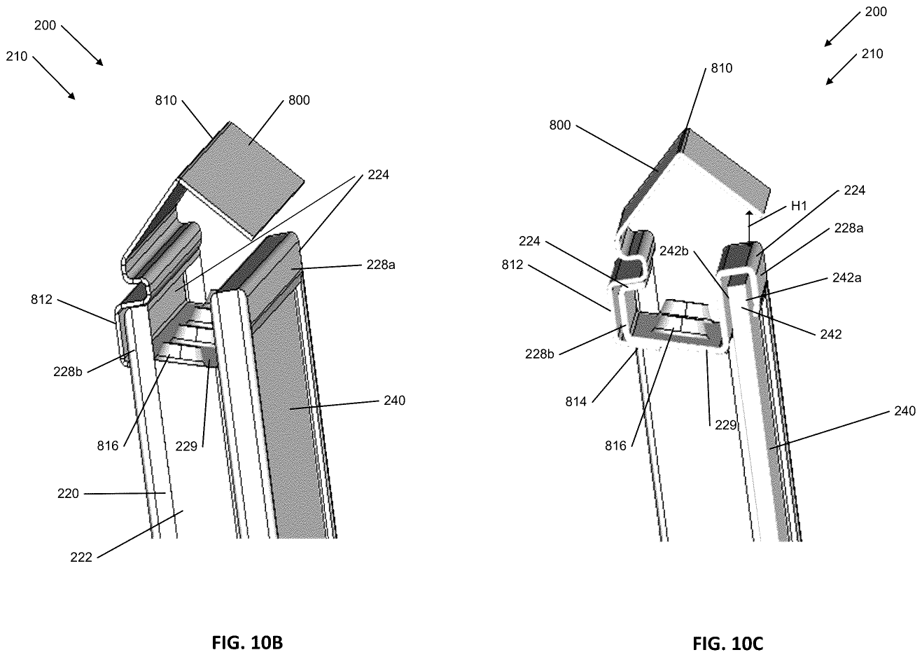

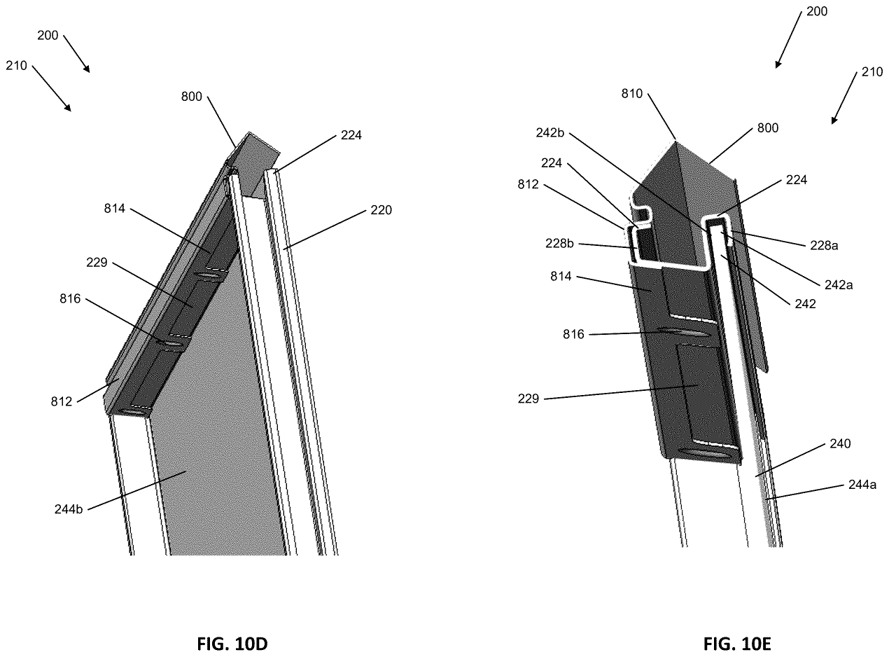

FIG. 10A is an example hail absorption wall 800, FIG. 10B is an enlarged view of the first side 210 of the solar module assembly 200 of FIG. 3B, shown in Circle 4, including the hail absorption wall 800, FIG. 10C is a cross-sectional view of the first side 210 of the solar module assembly 200, as in FIG. 10B, including the hail absorption wall 800, FIG. 10D is a bottom perspective view of the first side 210 of the solar module assembly 200 of FIG. 10B, including the hail absorption wall 800, and FIG. 10E is a cross-sectional view of the first side 210 of the solar module assembly 200, as in FIG. 10D, including the hail absorption wall 800.

As shown in FIGS. 10A to 10E, the hail absorption wall 800 may be attached to the frame 220 and may extend along the first wall 224 of the frame 220. In some examples, as shown in FIGS. 10A to 10E, the hail absorption wall 800 may be formed as a separate component and may be inserted around the first wall rear edge 228b. The hail absorption wall 800 extend in forward direction, beyond the sidewall front edge 242a. The hail absorption wall 800 may further extend in a rearward direction from the first wall 224 beyond the sidewall rear edge 242b, and the hail absorption wall 800 may further extend in a rearward direction beyond and around the first wall rear edge 228b.

The hail absorption wall 800 may further be spaced away, as indicated by arrow H₁, from the first wall 224. In some examples, the space between the hail absorption wall 800 and the first wall 224 may contain foam. The foam may be configured to absorb impact energy from the hail absorption wall 800 deflecting towards the first wall 224 in response to hail striking the hail absorption wall 800. The hail absorption wall 800 may be configured to provide protection to the protection zone 325 of the sidewall 242 by shielding a portion of the first side 210 of each of the plurality of solar module assemblies 150 (e.g., solar module assembly 200) from hail falling in a direction towards the first wall 224. In some cases, the hail absorption wall 800 may be configured to shield the portion of the first side 210 of the solar module assembly 200 by providing resiliency and by being deflectable towards the first wall 224 and/or by breaking up hail into fragments. As such, the hail absorption wall 800 may be configured to absorb impact energy from hail 350 falling in a direction towards the first wall 224, as indicated by arrow 352 in FIG. 5C.

As shown in FIGS. 10A to 10E, the hail absorption wall 800 may form a convex surface 810 extending away from the first wall 224. In some examples, the convex surface 810 may form one or more sharp edges. The sharp edges may function to break up or shatter hail, resulting in smaller and lighter hail fragments that may fall from the hail absorption wall 500 onto other surfaces (e.g., the sidewall 242, the solar module 240, etc.). Further, the hail absorption wall 800 may form a U-shaped bend 812 configured to be positioned against an outer side of the first wall rear edge 228b, and further extend along an underside of the channel 229 of the frame 220. The hail absorption wall 800 may then be configured to be coupled to the channel 229 of the first wall 224 via connectors 816. The connectors 816 may be formed via stamping and may be secured to the first wall 224 via bolts, screws, adhesives, snap-fit, or the like. In such cases, the channel 229 may include one or more openings 230 configured to engage with the one or more connectors 816. The contact between the connectors 816 and the first wall 224 secures the hail absorption wall 800 in position within the solar module assembly 200.

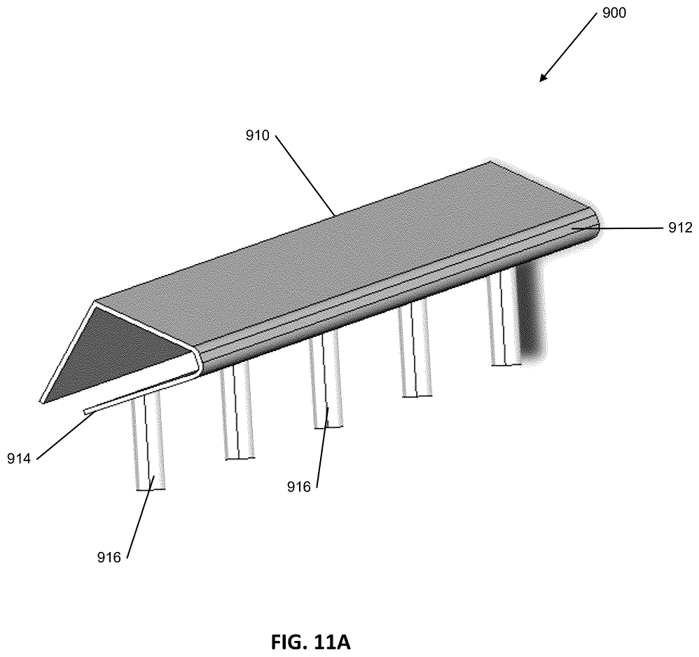

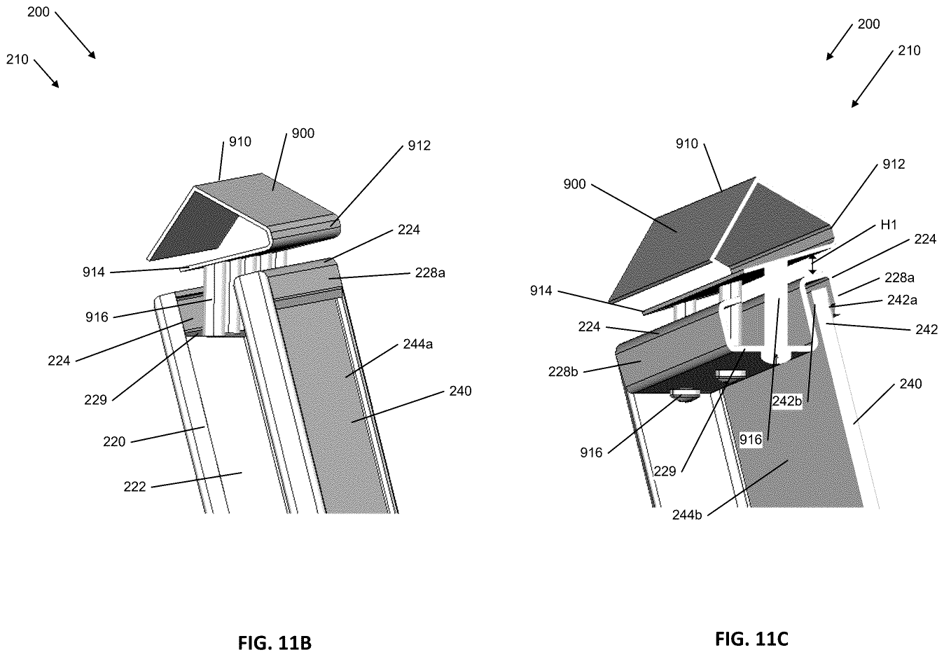

FIG. 11A is an example hail absorption wall 900, FIG. 11B is an enlarged view of the first side 210 of the solar module assembly 200 of FIG. 3B, shown in Circle 4, including the hail absorption wall 900, and FIG. 10C is a cross-sectional view of the first side 210 of the solar module assembly 200, as in FIG. 10B, including the hail absorption wall 900. As shown in FIGS. 11A to 11C, the hail absorption wall 900 may be attached to the frame 220 and may extend along the first wall 224 of the frame 220. In some examples, as shown in FIGS. 11A to 11C, the hail absorption wall 900 may be formed as a separate component and may be inserted within the channel 229 of the first wall 224 via one or more connectors 916. The one or more connectors 916 may include screws, bolts, snap-in connectors, or the like. The hail absorption wall 900 may extend in forward direction, beyond the sidewall front edge 242a. The hail absorption wall 900 may further extend in a rearward direction from the first wall 224 beyond the sidewall rear edge 242b, and the hail absorption wall 900 may further extend in a rearward direction beyond and around the first wall rear edge 228b.

The hail absorption wall 900 may further be spaced away, as indicated by arrow H₁, from the first wall 224. In some examples, the space between the hail absorption wall 900 and the first wall 224 may contain foam. The foam may be configured to absorb impact energy from the hail absorption wall 900 deflecting towards the first wall 224 in response to hail striking the hail absorption wall 900. The hail absorption wall 900 may be configured to provide protection to the protection zone 325 of the sidewall 242 by shielding a portion of the first side 210 of each of the plurality of solar module assemblies 150 (e.g., solar module assembly 200) from hail falling in a direction towards the first wall 224. In some cases, the hail absorption wall 900 may be configured to shield the portion of the first side 210 of the solar module assembly 200 by providing resiliency and by being deflectable towards the first wall 224 and/or by breaking up hail into fragments. As such, the hail absorption wall 900 may be configured to absorb impact energy from hail 350 falling in a direction towards the first wall 224, as indicated by arrow 352 in FIG. 5C.

As shown in FIGS. 11A to 11C, the hail absorption wall 900 may form a convex surface 910 extending away from the first wall 224. In some examples, the convex surface 910 may form one or more sharp edges. The sharp edges may function to break up or shatter hail, resulting in smaller and lighter hail fragments that may fall from the hail absorption wall 500 onto other surfaces (e.g., the sidewall 242, the solar module 240, etc.). Further, the hail absorption wall 900 may form a U-shaped bend 912 and a bottom surface 914. The hail absorption wall 900 may then be configured to be coupled to the channel 229 of the first wall 224 via connectors 916. The connectors 916 may extend therethrough from the bottom surface 914 to the channel 229 of the first wall 224 of the frame 220. In such cases, the channel 229 may include one or more openings 230 configured to engage with the one or more connectors 916. The contact between the connectors 916 and the openings 230 of the channel 229 in the first wall 224 secures the hail absorption wall 900 in position within the solar module assembly 200.

The example hail absorption walls (300, 400, 500, 600, 700, 800, 900) described herein may be formed from a sheet metal, such as a steel sheet. In some examples, the hail absorption walls (300, 400, 500, 600, 700, 800, 900) may be formed from aluminum, such as by extruding aluminum. In some examples, the hail absorption walls (300, 400, 500, 600, 700, 800, 900) may be formed from titanium, stainless steel, nickel alloys, platinum, or the like. The hail absorption walls (300, 400, 500, 600, 700, 800, 900) may be formed by bending with bends or folds to form the desired profile. The hail absorption walls (300, 400, 500, 600, 700, 800, 900) described herein may be configured to absorb up to 200 Joules of impact energy generated from the impact of damaging debris, such as hail.

Various non-limiting exemplary embodiments have been described. It will be appreciated that suitable alternatives are possible without departing from the scope of the examples described herein.

1. A solar tracking system, comprising:
a plurality of solar tracker rows arranged in parallel in a north-south direction;
each solar tracker row including:
a plurality of support piers;
a torque tube extending along the row and rotatably supported on the plurality of support piers;
a plurality of solar module assemblies with edge protection against hail damage coupled to the torque tube, each solar module assembly including:
a first side and a second side, opposite the first side;
a solar module that holds a plurality of photovoltaic cells, the solar module having a front surface configured to face the sun, the solar module having a sidewall extending away from the front surface;
a frame having a frame wall disposed about a perimeter of the solar module sidewall and supporting the solar module, the frame wall having a first wall on the first side; and
a hail absorption wall extending along and spaced from the first wall, the hail absorption wall being attached to the frame and shielding a portion of the first side of each one of the plurality of solar module assemblies from hail falling in a direction towards the first wall.

2. The solar tracking system of claim 1, wherein the hail absorption wall forms a convex surface extending away from the first wall.

3. The solar tracking system of claim 2, wherein the convex surface forms one or more sharp edges, whereby hail falling on the sharp edges may be broken into fragments.

4. The solar tracking system of claim 1, wherein the sidewall extends in a direction perpendicular to the front surface and defining a depth direction, the sidewall extends forward in the depth direction to a sidewall front edge and rearward in the depth direction to a sidewall rear edge.

5. The solar tracking system of claim 4, wherein the first wall extends forward in the depth direction to a first wall front edge and rearward in the depth direction to a first wall rear edge, the first wall front edge extending further forward in the depth direction than the sidewall front edge, the first wall rear edge extending further rearward in the depth direction than the sidewall rear edge.

6. The solar tracking system of claim 5, wherein the hail absorption wall extends forward in the depth direction past the first wall front edge.

7. The solar tracking system of claim 5, wherein the hail absorption wall extends rearward in the depth direction past the sidewall rear edge.

8. The solar tracking system of claim 1, wherein the space between the hail absorption wall and the first wall contains foam, the foam absorbing impact energy from the hail absorption wall deflecting towards the first wall in response to hail striking the hail absorption wall.

9. The solar tracking system of claim 1, wherein the hail absorption wall is resilient and deflectable towards the first wall, the hail absorption wall absorbing impact energy from hail falling in a direction towards the first wall.

10. The solar tracking system of claim 1, wherein the hail absorption wall is formed as a part of the first wall.

11. The solar tracking system of claim 1, wherein the hail absorption wall is formed as a component that is separate from the first wall.

12. The solar tracking system of claim 11, wherein the hail absorption wall is coupled to the first wall via friction fit, snap fit, or via connectors.

13. A solar module assembly with edge protection against hail damage, comprising:
a first sun-facing side and a second opposing side;
a solar module having a sidewall extending from the front surface;
a frame having a frame wall disposed about a perimeter of the solar module sidewall and supporting the solar module, the frame wall having a first wall on the first side; and
a hail absorption wall extending along and spaced from the first wall, the hail absorption wall being attached to the frame and shielding a portion of the first sun-facing side from hail falling in a direction towards the first wall.

14. The solar module assembly of claim 13, wherein the sidewall extends in a direction perpendicular to the front surface defining a depth direction, the sidewall extends forward in the depth direction to a sidewall front edge and rearward in the depth direction to a sidewall rear edge.

15. The solar module assembly of claim 14, wherein the first wall extends forward in the depth direction to a first wall front edge and rearward in the depth direction to a first wall rear edge, the first wall front edge extending further forward in the depth direction than the sidewall front edge, the first wall rear edge extending further rearward in the depth direction than the sidewall rear edge.

16. The solar module assembly of claim 15, wherein the hail absorption wall extends forward in the depth direction past the first wall front edge.

17. The solar module assembly of claim 15, wherein the hail absorption wall extends rearward in the depth direction past the sidewall rear edge.

18. The solar module assembly of claim 13, wherein the hail absorption wall is formed as a part of the first wall.

19. The solar module assembly of claim 13, wherein the hail absorption wall is formed as a component that is separate from the first wall.

20. The solar module assembly of claim 13, wherein the solar module assembly holds a plurality of photovoltaic cells, the solar module having a front surface and configured such that the plurality of photovoltaic cells generates a voltage when solar radiation passes through the front surface.

21. The solar module assembly of claim 13, wherein the hail absorption wall is resilient and deflectable towards the first wall, the hail absorption wall absorbing impact energy from hail falling in a direction towards the first wall.

22. The solar module assembly of claim 13, wherein the hail absorption wall forms a convex surface extending away from the first wall.

23. The solar module assembly of claim 22, wherein the convex surface forms one or more sharp edges, whereby hail falling on the sharp edges may be broken into fragments.
